(19) United States
(12) Patent Application Publication
(10) Pub. No.: US 2015/0106184 A1
(43) Pub. Date: Apr. 16, 2015

(54) DEVICE AND METHOD FOR MANAGING CERTIFICATION DATA

(71) Applicant: Furuno Electric Co., Ltd., Nishinomiya (JP)

(72) Inventors: Tsutomu Tanaka, Nishinomiya (JP); Masami Kishida, Nishinomiya (JP); Tadashi Tatsumi, Nishinomiya (JP)

(73) Assignee: Furuno Electric Co., Ltd., Nishinomiya (JP)

(21) Appl. No.: 14/395,415

(22) PCT Filed: Apr. 1, 2013
(86) PCT No.: PCT/JP2013/059847

§ 371 Date: Oct. 17, 2014

(30) Foreign Application Priority Data
Apr. 18, 2012 (JP) 2012-095135

(51) Int. Cl. G06Q 30/02; G06F 21/64

(52) U.S. Cl. CPC G06Q 30/0225; G06F 21/64
USPC 705/14.26

(57) ABSTRACT

A certification data management device that issues certification data easily editable on an administrator side while preventing copy and manipulation thereof, is provided. An access point device includes a communication unit, a data processing module, a memory controlling module, and a notification controlling module. The communicating unit is directly connectable with a communication terminal via wireless communication and acquires an interface ID (MAC address) used in the wireless communication, from the communication terminal. The data processing module issues certification data (electronic coupon) certifying a predetermined item. The memory controlling module performs a control of associating the interface ID with the certification data issued for the interface ID and storing them in a flash memory. The notification controlling module performs a control of transmitting, to the communication terminal, confirmation data (image of electronic coupon) indicating the issuance of the certification data, based on the information stored in the flash memory.

### TECHNICAL FIELD

This disclosure mainly relates to a wireless access point device which is able to issue certification data, such as an electronic coupon, and relates to a wireless LAN router, and the like.

### BACKGROUND ART

Conventionally, information supply devices have been known, which are installed, for example, in shopping centers and at exhibitions and provide coupons and written materials wirelessly. Such an information supply device has, for example, a wireless LAN function and can connect with communication terminals (e.g., mobile phones, tablet terminals, and notebook computers) of customers and visitors. Further, the customers and the visitors can download the coupons and the like from the information supply device by utilizing browsers and dedicated software and the like. Patent Documents 1 and 2 disclose such kind of information supply devices.

The information supply device disclosed in Patent Document 1 has a function (redirect function) to cause a communication terminal accessing the information supply device by using a browser, to display a predetermined page regardless of an URL specified by the browser.

The information supply device (a coupon server and a wireless base station) disclosed in Patent Document 2 has a configuration of utilizing terminal IDs of communication terminals. Specifically, the coupon server stores, in association with the terminal IDs, information of, for example, coupons of restaurants desired by users of the communications terminals. Further, for example, the mobile phone is placed near the wireless base station and a store personnel performs predetermined processing to transmit an electronic coupon determined by the coupon server to the mobile phone. Note that, cryptographic technologies, such as electronic certification, are utilized for the electronic coupon to be transmitted to prevent it from being copied and manipulated.

### REFERENCE DOCUMENTS OF CONVENTIONAL ART

### Patent Document(s)

Patent Document 1: JP2011-253293A
Patent Document 2: JP2001-216449A

### DISCLOSURE OF THE INVENTION

### Problems to be Solved by the Invention

However, since the configuration of Patent Document 2 requires encryption as described above, a process amount of each equipment increases and high introduction and operational costs of the system of the encryption are required. Moreover, in the case of introducing the system of the encryption, a dedicated application needs to be installed in the mobile phone. Therefore, the configuration of Patent Document 2 has problems that the costs increase and it is troublesome to the users.

Moreover, with the configuration of Patent Document 2, since the information of the electronic coupon is on the mobile phone side, it has been difficult to change conditions of use and the like after the electronic coupon is issued. Specifically, when changing the contents of the electronic coupon according to either one of an amount of visiting customers and weather, the change needs to be notified and the electronic coupon needs to be downloaded again, and thus, flexible performance could not be given.

Moreover, when identifying a terminal by using a mobile phone, individual identifying information (e.g., UDID) may generally be utilized. However, the individual identifying information may be utilized, for example, for a case of payment, and it requires careful handling. Therefore, for example, in transmitting the individual identifying information, agreement is required from a user in some cases, and the electronic coupon cannot be used smoothly in such cases.

Note that, the above problems do not occur only with the electronic coupons used in shopping centers and the like, but they occur commonly when handling data that certifies a predetermined item.

This disclosure is made in view of the above situations and aims to provide a certification data management device, which issues certification data easily editable on an administrator side, while preventing the certification data from being copied and manipulated.

### Summary and Effect(s) of the Invention

Problems to be solved by this disclosure are described above, and means for solving the problems and effects thereof will be described below.

According to a first aspect of this disclosure, a certification data management device with the following configuration is provided. That is, the certification data management device includes a communication unit, a data processing module, a memory controlling module, and a notification controlling module. The communication unit is directly connectable with a communication terminal via wireless communication and acquires an interface ID used in the wireless communication, from the communication terminal. The data processing module issues certification data certifying a predetermined item. The memory controlling module performs a control of storing, in a memory, the interface ID and the certification data issued for the interface ID in association with each other. The notification controlling module performs a control of transmitting, to the communication terminal, confirmation data indicating that the certification data is issued, based on the information stored in the memory.

Thus, since the configuration in which, instead of the certification data, the confirmation data is transmitted to the communication terminal is adopted, the certification data can be managed on an administrator side instead of a user side of the communication terminal. Therefore, the cost of measures against copy and manipulation can be reduced. Moreover, since the interface ID causes less influence in case of leakage compared to the individual identifying number (e.g., UDID) of the terminal, the ease of handling the information can be improved.

With the certification data management device, the data processing module preferably deletes or changes the certification data.

In this disclosure, since the certification data is stored in, instead of the communication terminal, equipment (the memory) on the administrator side as described above, the certification data can be edited easily. Therefore, flexible performance according to, for example, the situation can be given.

With the certification data management device, information to be firstly displayed on the communication terminal when the communication unit is connected with the communication terminal is preferably changed depending on whether the interface ID of the communication terminal is stored in the memory.

Thereby, service usage and the like can be displayed on the communication terminal connected with the communication unit for the first time, while a screen for providing the service can be displayed on the communication terminal that has connected with the communication unit in the past. Therefore, a user-friendly configuration can be achieved.

With the certification data management device, the information to be displayed on the communication terminal when the communication unit is connected with the communication terminal is preferably changed according to the certification data stored in association with the interface ID of the communication terminal.

Thereby, the certification data management device can display an issued certification data list and, when certification data nearly expired exists, the certification data management device can display such situation. Therefore, a more flexible and convenient configuration can be achieved.

With the certification data management device, the memory is preferably detachable.

Thereby, the certification data management device can easily cope with, e.g. a case of switching the memory to be used depending on time.

The certification data management device preferably includes a display unit configured, when the communication unit is connected with the communication terminal, to display the connected situation.

Thereby, the user can grasp visually that the communication terminal is connected with the certification data management device.

With the certification data management device, the memory controlling module preferably performs either one of a control of changing the interface ID associated with the certification data and a control of adding the interface ID associated with the certification data.

Thereby, the interface ID can be changed, and therefore, the certification data can be taken over, for example, when replacing the communication equipment. Moreover, since the interface ID can be added, it is possible to share the certification data among two or more people, for example.

With the certification data management device, a network name for being used to issue the certification data to the connected communication terminal, and a network name for being used to manage the certification data management device are preferably provided.

Thereby, for example, setting of the certification data management device can be changed via wireless communication. Therefore, a process, such as temporarily suspending the issuance of the certification data, can be performed easily.

With the certification data management device, the certification data is preferably data certifying a right to receive a predetermined service.

Thereby, this disclosure can be utilized for, for example, electronic coupons in shopping centers.

With the certification data management device, in either one of a case where the predetermined service is provided based on the certification data and a case where the certification data is expired, the data processing module preferably registers the situation of the either one of the cases in the memory or deletes the certification data from the memory.

Thereby, a configuration of automatically deleting, for example, the electronic coupon on the memory side (on the administrator side) can be achieved.

With the certification data management device, the certification data is preferably data certifying that the communication terminal is within a communicable range of the communication unit.

Thereby, this disclosure can be applied to, for example, attendance checking and a stamp collecting event.

According to a second aspect of this disclosure, a method of managing certification data with the following configuration is provided. That is, the method includes directly connecting with a communication terminal via wireless communication and acquiring an interface ID used in the wireless communication, from the communication terminal. The method includes issuing certification data certifying a predetermined item. The method includes storing, in a memory, the interface ID and the certification data issued for the interface ID in association with each other. The method includes transmitting, to the communication terminal, confirmation data indicating that the certification data is issued, based on the information stored in the memory.

Thereby, the certification data can be managed on an administrator side instead of a user side of the communication terminal. Therefore, the cost of measures against copy and manipulation can be reduced. Moreover, since the interface ID causes less influence in case of leakage compared to the individual identifying number (e.g., UDID) of the terminal, the ease of handling the information can be improved.

According to a third aspect of this disclosure, a certification data management device with the following configuration is provided. That is, the certification data management device includes a communication unit, a data processing module, and a memory controlling module. The communication unit is directly connectable with a communication terminal via wireless communication and acquires an interface ID used in the wireless communication, from the communication terminal. The data processing module issues certification data certifying a predetermined item. The memory controlling module performs a control of storing, in a memory, the interface ID and the certification data issued for the interface ID in association with each other.

Thereby, the certification data can be managed on an administrator side instead of a user side of the communication terminal. Therefore, the cost of measures against copy and manipulation can be reduced. Moreover, since the interface ID causes less influence in case of leakage compared to the individual identifying number (e.g., UDID) of the terminal, the ease of handling the information can be improved.

### BRIEF DESCRIPTION OF DRAWINGS

FIG. 1 is an overall configuration of an access point device according to one embodiment of this disclosure.

FIG. 2 shows tables for describing contents stored in a flash memory.

FIG. 3 is a sequence diagram for describing a flow of acquisition and use of an electronic coupon.

### MODE(S) FOR CARRYING OUT THE INVENTION

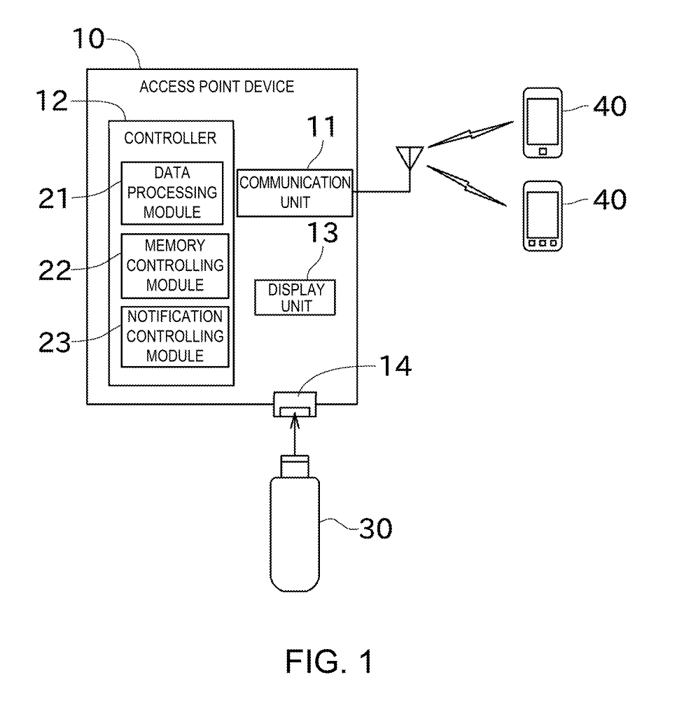

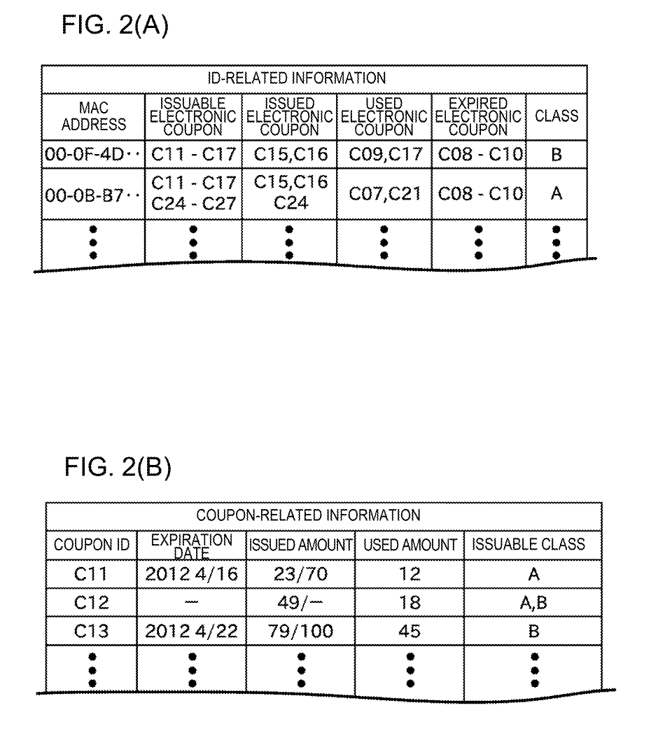

Next, one embodiment of this disclosure is described with reference to the drawings. FIG. 1 is an overall configuration of an access point device 10 according to one embodiment of this disclosure. FIG. 2 shows tables for describing contents stored in a flash memory.

First, an outline of the access point device 10 is described. The access point device 10 of this embodiment is installed in a shopping center. The access point device 10 is connectable, via wireless LAN, with a plurality of communication terminals 40 (specifically, smart phones, tablet terminals, and the like) possessed by customers, and can issue electronic coupons to the plurality of communication terminals 40 connected therewith.

The customers can use the electronic coupons to receive predetermined services and predetermined discounts in stores within the shopping center. Note that, the access point device 10 of this embodiment is not for providing internet connection to the customers, and therefore, it is not connected to internet.

Hereinafter, a configuration of the access point device 10 is described in detail. As illustrated in FIG. 1, the access point device 10 includes a communication unit 11, a controller 12, a display unit 13, and a USB terminal 14. Moreover, the access point device 10 is connected with the plurality of communication terminals 40 as described above.

The communication unit 11 can exert a function as a base unit of the wireless LAN. Specifically, two SSIDs are set in the access point device 10. One of the SSIDs is for being used by the customers and is displayed at respective locations inside the shopping center. Each customer controls the communication terminal 40 to display, for example, a network setting screen and select the SSID of the access point device 10. Thus, the customer can connect the communication terminal 40 with the access point device 10. Moreover, the communication unit 11, when connecting with the communication terminal 40, acquires a MAC address (interface ID) of the communication terminal 40. In this embodiment, the customer is identified based on the MAC address.

Moreover, the other SSID is for an administrator (manager) of the shopping center to connect and perform management of the access point device 10. Therefore, a security function, such as a password, stealth and MAC address filtering, is set in connecting by using the SSID. By connecting the access point device 10 by using the SSID, the administrator can change, for example, information of each customer and setting of each electronic coupon.

The controller 12 performs various controls of the access point device 10, and is comprised of a CPU, a RAM, a ROM, etc. Specifically, the controller 12 includes a data processing module 21, a memory controlling module 22, and a notification controlling module 23.

Based on, for example, instruction from the customer, the data processing module 21 issues the electronic coupon to the customer. The memory controlling module 22 performs a control of storing, in a flash memory 30 described later, the electronic coupon issued by the data processing module 21, and the MAC address in association with each other. The notification controlling module 23 transmits data indicating that the electronic coupon is issued (either one of an issued electronic coupon list and an electronic coupon image to be shown to a store personnel), to the communication terminal 40.

The display unit 13 is a display disposed on a surface of the access point device 10. The display unit 13 can display various kinds of information. For example, when the connection from the communication terminal 40 is successful, the connected situation can be displayed, name(s) of electronic coupon(s) that can be currently provided can be displayed, and the SSID of the access point device 10 can be displayed. Note that, the display unit 13 is not limited to the display, and for example, it may include a plurality of lamps and be configured to be turned on in a predetermined mode when the connection from the communication terminal 40 is successful.

The USB terminal 14 is configured such that the flash memory 30 having the USB terminal can be attached thereto. Moreover, instead of the USB terminal 14, either one of a slot into which a memory card and the like can be inserted and a drive that can read a disc, such as a DVD, may be adopted. Furthermore, either one of a hard disk and an SSD (Solid State Drive) may also be adopted.

The flash memory 30 stores ID-related information that is information regarding each customer, and coupon-related information that is information regarding each kind of coupons. Note that, the dividing of the information to be stored is merely an example, and the flash memory 30 may be configured to manage these kinds of information integrally.

As illustrated in FIG. 2(A), the ID-related information is information associating the MAC address, one or more kinds of electronic coupons issuable to the communication terminal 40 corresponding to the MAC address, one or more kinds of electronic coupons already issued to the communication terminal 40, one or more kinds of electronic coupons used by the communication terminal 40, one or more kinds of electronic coupons expired for the communication terminal 40, and a class of the communication terminal 40 with each other. The “class” indicates a rank of each customer and it is determined by, for example, either one of whether the customer is a dues-paying member and whether the number of the used electronic coupons by the customer is higher than a predetermined value. In this embodiment, the issuable kind of electronic coupon is different depending on the class.

As illustrated in FIG. 2(B), the coupon-related information stores an ID of each kind of electronic coupon, an expiration date and/or time of the electronic coupon, a currently issued amount and an upper limit of an issuable amount of the electronic coupon, an amount of times the electronic coupon has been used, and a class for which the electronic coupon can be issued, associated with each other. Therefore, for example, regarding an electronic coupon of which ID is C11, it can be understood that the expiration date and/or time is Apr. 16, 2012, the upper limit of the issuable amount is seventy and the currently issued amount is twenty three, the current amount of times being used is twelve, and the issuable class is A.

The ID-related information and the coupon-related information are merely an example, and various items can be added and changed. For example, when the electronic coupon is not collected after being used only once and it can be used a plurality of times, an item, such as “usable amount of times” can be provided to the coupon-related information. Moreover, by associating the plurality of MAC addresses with the information of the electronic coupons, a configuration in which the same kind of electronic coupon can be used by two or more people, (or a plurality of terminals) may be adopted.

The administrator of the shopping center can, for example, delete, add and rewrite the information by utilizing the SSID for management described above. Therefore, the administrator can set the upper limit of the issuable amount of each kind of electronic coupon according to the amount of visiting customers on the day, and can change a discount rate only for a fixed period of time. Moreover, when the customer replaces the communication terminal 40, by rewriting the MAC address, the information of the electronic coupon(s) can be taken over. These functions can be achieved because an original of each electronic coupon is stored in the flash memory 30 on the administrator side, and they cannot be easily achieved with the conventional configuration in which the original of the electronic coupon is transmitted to the mobile phone.

Note that, in this embodiment, the flash memory 30 is easily detachable, and therefore, it is easy to also remove the flash memory 30 and insert it into a PC or the like to change the information and create a backup thereof.

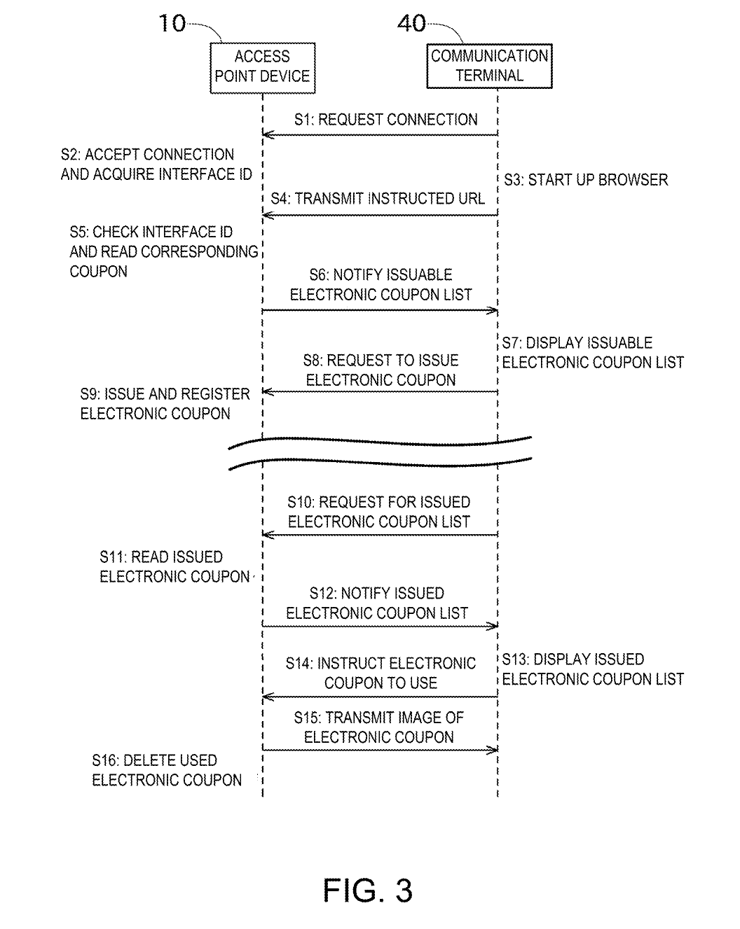

Next, a flow of the customer to acquire the electronic coupon from the access point device 10 and use it is described. FIG. 3 is a sequence diagram for describing the flow of the acquisition and the use of an electronic coupon.

The SSID of the access point device 10 is displayed at the respective locations inside the shopping center. For example, the customer displays a screen of network setting or the like on the communication terminal 40, and selects the SSID as a connecting destination. Thus, the communication terminal 40 requests the access point device 10 to connect therewith (Sequence No. S1).

The access point device 10 accepts the request and acquires the MAC address (interface ID) of the communication terminal 40 (Sequence No. S2). As described above, in this embodiment, the MAC address is used as the ID of the communication terminal 40. The MAC address causes less influence in a case of leakage, compared to an individual identifying number (e.g., UDID) of the communication terminal 40. Therefore, the ease of handling the information can be improved. Particularly in this embodiment, since the access point device 10 is not connected to internet, there is no risk of unauthorized access via internet, and thus, leakage itself hardly occurs.

Then the communication terminal 40 connects with the access point device 10. Next, through the control by the customer, the communication terminal 40 starts up a Web browser (Sequence No. S3). The communication terminal 40 transmits a URL specified by the customer (may be an arbitrary URL) to the access point device 10 (Sequence No. S4).

The access point device 10 has a redirect function and can display contents of its own on the communication terminal 40 regardless of the URL instructed by the customer. Here, the access point device 10 changes the information to be displayed on the communication terminal 40 based on the ID-related information.

Specifically, the access point device 10 determines whether the MAC address acquired at Sequence No. S2 is registered in the ID-related information (Sequence No. S5). If the MAC address is not registered in the ID-related information, the access point device 10 causes the corresponding communication terminal 40 to display, for example, usage guide. On the other hand, if the MAC address is registered in the ID-related information, the access point device 10 notifies an issuable electronic coupon list to the corresponding communication terminal 40, based on, for example, the issuable class corresponding to the communication terminal 40 (Sequence No. S6).

The communication terminal 40, in response to the notification, displays the issuable electronic coupon list on the display of the communication terminal 40 (Sequence No. S7). Note that, a configuration in which when electronic coupon(s) already issued exists, instead of or in addition to the issuable electronic coupon(s), the issued electronic coupon(s) is displayed, may be adopted.

In the “issuable electronic coupon list” displayed on the communication terminal 40, description of, for example, contents and expiration date and/or time of the electronic coupon(s) is given. The customer selects an electronic coupon that he/she desires to be issued, based on the description. Thus, the communication terminal 40 requests, to the access point device 10, for the issuance of the electronic coupon (Sequence No. S8).

The access point device 10, in response to the request, issues the electronic coupon and registers the issuance of the electronic coupon in the ID-related information (Sequence No. S9). The issuance of the electronic coupon is performed as above.

Next, a flow of using the issued electronic coupon is described.

Based on an instruction from the customer, the communication terminal 40 requests, to the access point device 10, for the issued electronic coupon list (Sequence No. S10). The access point device 10, in response to the request, accesses the ID-related information to read the relative electronic coupon(s) (Sequence No. S11). Further, the access point device 10 notifies the issued electronic coupon list to the communication terminal 40 (Sequence NO. S12). Then, the communication terminal 40 displays the issued electronic coupon list on the display (Sequence No. S13).

The customer selects an electronic coupon to use, from the electronic coupon list. Thus, the communication terminal 40 notifies the electronic coupon to use, to the access point device 10 (Sequence No. S14).

The access point device 10, in response to the notification, transmits an image of the notified electronic coupon to the communication terminal 40 (Sequence No. S15). The image is not the electronic coupon itself, but it indicates that the electronic coupon is issued (confirmation data). The shop personnel looks at the image and performs, for example, discount processing.

Note that, to prevent the image from being copied and used, for example, the image may be changed depending on either one of date and time, and information that is not saved only by saving the image (e.g., display of counting down to the expiration date and/or time) may be added. In this embodiment, since the image of the electronic coupon is saved on the administrator side, such processing can be performed easily.

Further, the access point device 10 deletes the used electronic coupon from the “issued electronic coupon(s)” in the ID-related information, as well as adds the used electronic coupon to the “used electronic coupon(s)” (Sequence No. S16). As above, the issuance and the deleting of the electronic coupon are performed.

Moreover, the access point device 10 periodically checks the expiration date and/or time of the electronic coupon. Then, the access point device 10 adds the electronic coupon after its expiration date and/or time, to “expired electronic coupon” of ID-related information.

As described above, the access point device 10 includes the communication unit 11, the data processing module 21, the memory controlling module 22, and the notification controlling module 23. The communication unit 11 is directly connectable with the communication terminal 40 via wireless communication, and acquires the interface ID (MAC address) used in the wireless communication, from the communication terminal 40. The data processing module 21 issues the certification data (electronic coupon) certifying a predetermined item. The memory controlling module 22 performs the control of storing, in the flash memory 30, the interface ID and the certification data issued for the interface ID in association with each other. Based on the information stored in the flash memory 30, the notification controlling module 23 performs the control of transmitting the confirmation data (the image of the electronic coupon) indicating that the certification data is issued, to the communication terminal 40.

According to the above, the configuration in which, instead of the certification data, the confirmation data is transmitted to the communication terminal 40 is adopted; therefore, the certification data can be managed on the administrator side instead of a user side of the communication terminal 40. Therefore, the cost of measures against copy and manipulation can be reduced. Moreover, since the interface ID causes less influence in a case of leakage compared to the individual identifying number (e.g., UDID) of the terminal, the ease of handling the information can be improved.

Although the preferred embodiment of this disclosure is described above, the above configuration may be modified as follows, for example.

In the above description, the example of applying this disclosure to the electronic coupon is described; however, alternatively, this disclosure may be applied to, for example, a stamp collecting event, attendance checking, product reservation confirmation, and management of waiting lines at theme parks and the like. For example, in the stamp collecting event and attendance checking, certification data certifying that the terminal was near the access point device 10 is issued, and the confirmation data indicating the certification is notified to a user.

The method (standard) of connecting the access point device 10 with the communication terminal 40 is not limited to wireless LAN.

In the above description, the access point device was given as an example of applying the certification data management device; however, this disclosure can be applied to servers and tablet terminals as long as it has a configuration with a similar function to the above example.

Alternative to the above configuration, a configuration in which a part of the certification data management device is disposed at a separate location with either one of a wire and no wire may be adopted. For example, either one of the controller 12 and the memory may be located at a separate location to the access point device 10. In the present application, even such a configuration partially disposed at a physically separate location corresponds to the “certification data management device.”

### DESCRIPTION OF REFERENCE NUMERAL(S)

10 Access Point Device (Certification Data Management Device)
11 Communication Unit
12 Controller
13 Display Unit
14 USB Terminal
30 Flash Memory (Memory)
40 Communication Terminal

1. A certification data management device, comprising:
a communication unit configured to be directly connectable with a communication terminal via wireless communication and acquire an interface ID used in the wireless communication, from the communication terminal;
a data processing module configured to issue certification data certifying a predetermined item;
a memory controlling module configured to perform a control of storing, in a memory, the interface ID and the certification data issued for the interface ID in association with each other; and
a notification controlling module configured to perform a control of transmitting, to the communication terminal, confirmation data indicating that the certification data is issued, based on the information stored in the memory.

2. The certification data management device of claim 1, wherein the data processing module deletes or changes the certification data.

3. The certification data management device of claim 1, wherein information to be firstly displayed on the communication terminal when the communication unit is connected with the communication terminal is changed depending on whether the interface ID of the communication terminal is stored in the memory.

4. The certification data management device of claim 3, wherein the information to be displayed on the communication terminal when the communication unit is connected with the communication terminal is changed according to the certification data stored in association with the interface ID of the communication terminal.

5. The certification data management device of claim 1, wherein the memory is detachable.

6. The certification data management device of claim 1, comprising a display unit configured, when the communication unit is connected with the communication terminal, to display the connected situation.

7. The certification data management device of claim 1, wherein the memory controlling module performs either one of a control of changing the interface ID associated with the certification data and a control of adding the interface ID associated with the certification data.

8. The certification data management device of claim 1, wherein a network name for being used to issue the certification data to the connected communication terminal, and a network name for being used to manage the certification data management device are provided.

9. The certification data management device of claim 1, wherein the certification data is data certifying a right to receive a predetermined service.

10. The certification data management device of claim 9, wherein in either one of a case where the predetermined service is provided based on the certification data and a case where the certification data is expired, the data processing module registers the situation of the either one of the cases in the memory or deletes the certification data from the memory.

11. The certification data management device of claim 1, wherein the certification data is data certifying that the communication terminal is within a communicable range of the communication unit.

12. A method of managing certification data, comprising:
directly connecting with a communication terminal via wireless communication and acquiring an interface ID used in the wireless communication, from the communication terminal;
issuing certification data certifying a predetermined item;
storing, in a memory, the interface ID and the certification data issued for the interface ID in association with each other; and
transmitting, to the communication terminal, confirmation data indicating that the certification data is issued, based on the information stored in the memory.

13. A certification data management device, comprising:
a communication unit configured to be directly connectable with a communication terminal via wireless communication and acquire an interface ID used in the wireless communication, from the communication terminal;
a data processing module configured to issue certification data certifying a predetermined item; and
a memory controlling module configured to perform a control of storing, in a memory, the interface ID and the certification data issued for the interface ID in association with each other.

14. The certification data management device of claim 1, wherein the interface ID is MAC address of the communication terminal.

15. The method of managing certification data of claim 12, wherein the interface ID is MAC address of the communication terminal.

16. The certification data management device of claim 13, wherein the interface ID is MAC address of the communication terminal.
